(19) United States
(12) Patent Application Publication
(10) Pub. No.: US 2018/0268386 A1
(43) Pub. Date: Sep. 20, 2018

(54) Identity Management Distributed Ledger and Blockchain

(71) Applicants: C. Jay Wack, Clarksburg, MD (US); Edward M. Scheidt, McLean, VA (US)

(72) Inventors: C. Jay Wack, Clarksburg, MD (US); Edward M. Scheidt, McLean, VA (US)

(21) Appl. No.: 15/703,433

(22) Filed: Sep. 13, 2017

Related U.S. Application Data
(60) Provisional application No. 62/393,810, filed on Sep. 13, 2016.

(51) Int. Cl. G06Q 20/10; G06Q 20/22; G06F 21/60; H04L 29/06; H04L 9/08; H04L 9/06

(52) U.S. Cl. CPC G06Q 20/102; G06Q 20/223; G06F 21/602; H04L 63/0428; H04L 2209/38; H04L 63/06; H04L 9/085; H04L 9/0637; H04L 63/10

(57) ABSTRACT

A method of providing a cryptographic platform for exchanging information includes identifying a first information transaction stored within a blockchain sequence that provides a mathematically verifiable record of information transactions. The first information transaction includes a first information transaction identifier, associated with the first party such that the first information transaction identifier provides identification of the information transferred to the first party and stored within the blockchain, and a first information payload. The first information transaction is identified based on the first information transaction identifier, to provide a first information identifier that includes a hash of the first information payload. A system for providing a cryptographic platform for exchanging information includes an interface configured to receive split key values associated with attributes reflecting a taxonomy, and physical computer processors processors are coupled for communication with the interface and configured to identify a first information transaction stored within a blockchain sequence.

### CROSS-REFERENCE TO RELATED APPLICATIONS

This is related to, and claims priority from, U.S. Provisional Application for Patent No. 62/393,810, which was filed on Sep. 13, 2016, the disclosure of which is incorporated herein in its entirety.

The disclosures of the following patents and published patent applications are incorporated herein in their entireties: U.S. Pat. No. 7,131,009; U.S. Pat. No. 7,111,173; U.S. Pat. No. 7,095,852; U.S. Pat. No. 7,095,851: U.S. Pat. No. 7,089,417; U.S. Pat. No. 7,079,653; U.S. Pat. No. 7,069,448 U.S. Pat. No. 7,016,495; U.S. Pat. No. 6,845,453; U.S. Pat. No. 6,754,820; U.S. Pat. No. 6,694,433; U.S. Pat. No. 6,684,330; U.S. Pat. No. 6,608,901; U.S. Pat. No. 6,606,386; U.S. Pat. No. 6,549,623; U.S. Pat. No. 6,542,608; U.S. Pat. No. 6,490,680; U.S. Pat. No. 6,266,417; U.S. Pat. No. 6,229,445; U.S. Pat. No. 6,075,865; U.S. Pat. No. 5,898,781; U.S. Pat. No. 5,787,173; U.S. Pat. No. 5,680,452; U.S. Pat. No. 5,432,851; U.S. Pat. No. 5,410,599; U.S. Pat. No. 5,375,169 U.S. Pat. No. 5,369,707; U.S. Pat. No. 5,369,702; US 20090097657.

CKM as described herein is also incorporated in numerous standards (9.69, X9.73, X9.84, X9.96) published by the American National Standards Institute (ANSI) and is incorporated into ISO 22895 which includes reference to the cited ANSI standards. Thee standards are also incorporated herein in their entireties, as are the disclosures of the following documents:

IETF RFC 4422—Simple Authentication and Security (SASL)

ANSI x9.73 Cryptographic Message Syntax—ASN.1 and XML

### FIELD OF THE INVENTION

The invention relate to systems and methods of blockchain security.

### BACKGROUND OF THE INVENTION

The financial community is looking for a faster and more secure payment system. Many events have given inertia towards a new way to do banking from the traditional methods. Much has been written, and it is anticipated much will be written, regarding digital payment methods.

The current digital discussion has also expanded into the subject of alternative currencies such as digital currencies. In recent time, a model has emerged that had genesis with a digital asset platform identified as Bitcoin. Basically, the Bitcoin architecture includes three fundamental parts:

1. A Miner, or the entity that would generate something digital that could be used as a means of exchange,

2. A means of communicating the exchange, such as the Internet, and

3. A settlement process between two persons, one who would have something to sell and a purchaser who had the Miner's digital value representation.

Bitcoin was able to demonstrate that a faster financial exchange was possible which included a Hash math function for the security of the parties. Since Bitcoin's emergence, many business models have emerged including Blockchain and Distributive Ledgers. In some instances, variations with Bitcoin are used in the financial market, but the financial community has, also put forth alternatives to Sitcom with a goal of a secure, faster payment.

The encryption found in the Blockchain cryptography, and the ledger concept identified with the financial services, may have applicability in other vertical business markets beyond the financial sector.

The Distributive Ledger is emerging as a new tool or doing business. A recent Guardian commentary summed up their view with the following:
A distributed ledger is a special kind of database that is spread across multiple sites, countries or institutions, and is typically public in the sense that anyone can view it. Entries in the database are configured in “blocks” which are then chained together using digital cryptographic signatures—hence the term blockchain, which is really just a techie name for a distributed ledger that can be shared and corroborated by anyone who has the appropriate permissions. (The Guardian, John Naughton, 24 Jan. 2016).
   The United States financial sector is developing their concepts in parallel with other international bodies.

The invention includes a Distributive Ledger and the supporting Blockchain technology based on standards,on public digital technology, on private digital technology, and on IP technology. Financial sector applications are described herein as an example of industrial applicability of the invention. The scope of the invention, however is not limited to these particular disclosed applications or to applications related thereto.

Blockchain can exist for various segments identified with security. Annex A broadens the scope of security to include security categories that can define the enterprise security environment. Information security is one of these security categories.

### BRIEF SUMMARY OF THE INVENTION

According to an aspect of the invention, a system for providing a cryptographic platform for exchanging information within an organization includes an interface configured to receive prepositioned split key values associated with attributes reflecting a taxonomy of the organization, and one or more physical computer processors. The processors are coupled for communication with the interface and configured by machine-readable instructions to identify a first information transaction stored within a blockchain sequence that provides a verifiable record of information transactions. The first information transaction represents an immutable record of a transfer of information to a first party, and includes a first information transaction identifier and a first information payload. The first information transaction identifier is associated with the first party and provides identification of the information transferred to the first party and stored within the blockchain encrypted based on a transaction ephemeral key created from the prepositioned split values. The first information transaction is identified based on the first information transaction identifier. The first information identifier includes a hash of the first information payload enabling the auditing and verification of the information transferred to the first party and stored within the block chain, in its encrypted state and as such without disclosing the information transferred to the first party.

The first information payload can include an attribute based, split key-constructed payload ephemeral key based encrypted version of the information transferred to the first part, in which case the encrypted version is encrypted using a payload ephemeral key associated with the first party and participating organizational key values so that the information transferred to the first party and stored within the blockchain is not publicly accessible via the blockchain.

The one or more physical computer processors can be further configured by the machine-readable instructions to retrieve the first information payload from the first information transaction stored within the blockchain decrypt the encrypted version of the information transferred to the first party using a decryption ephemeral key construction based on split values reflecting the taxonomy of the organization of interest inclusive of at least the first party that corresponds to the intent of the access desired by at least the first party, and facilitate presentation of the decrypted information to the first, party via an electronic display.

The one or more physical computer processors can be further configured by the machine-readable instructions to identify a second party as a source of the first information transaction, and receive second information from the first party. The second information includes a communication intended for the second party.

The one or more physical computer processors can be further configured by the machine-readable instructions to encrypt the second information with a second transfer ephemeral key construction based on split values reflecting the taxonomy of the organization of interest inclusive of the first and second parties that corresponds to the intent of the access desired by the first and second parties.

The one or more physical computer processors can be further configured by the machine-readable instructions to generate a second information transaction including a second information payload. The second information payload includes a first portion and a second portion. The first portion is encrypted using a first portion payload ephemeral key construction based on split values reflecting the taxonomy of the organization of interest inclusive of the first and second parties that corresponds to the intent of the access desired by the first and second parties. The second portion is encrypted using a second portion payload ephemeral key construction based on split values reflecting the taxonomy of the organization of interest inclusive of the first and second parties that corresponds to the intent of the access desired by the first and second parties.

The system can also include at least one key split generator, configured to couple for communication with the interface and to generate the prepositioned split key values.

According to another aspect of the invention is a method of providing a cryptographic platform for exchanging information, implemented on a computer system having one or more physical processors configured by machine-readable instructions which, when executed, perform the method. The method includes identifying a first information transaction stored within a blockchain sequence that provides a mathematically verifiable record of information transactions. The first information transaction represents an immutable record of a transfer of information to a first party and includes a first information transaction identifier and a first information payload. The first information transaction identifier is associated with the first party such that the first information transaction identifier provides identification of the information transferred to the first party and stored within the blockchain. The first information transaction is identified based on the first information transaction identifier, to provide a first information identifier that includes a hash of the first information payload, thereby enabling auditing of the information transferred to the first party and stored within the block chain without disclosing the information transferred to the first party.

The first information payload can include an encrypted component, which is computed using a payload ephemeral key construction based on split values. The method can also include generating the split values. The split values can reflect a taxonomy of an organization of interest inclusive of the first party, and possibly of at least one other party, corresponding to an intent of access desired by participants in the first information transaction. Preferably, the included parties are those participating in the transaction. The organization of interest can be a community of interest.

The information transferred to the first party can be encrypted using a transfer ephemeral key construction based on split values reflecting the taxonomy of the organization of interest inclusive of the first party corresponding to the intent of access desired by at least the first party in the first information transaction, thereby rendering the information transferred to the first party and stored within the blockchain inaccessible publicly via the blockchain. The first information payload can be retrieved from the first information transaction stored within the blockchain, and the encrypted information transferred to the first party can be decrypted using a decryption ephemeral key construction based on split values reflecting the taxonomy of the organization of interest inclusive of at least the first party that corresponds to the intent of the access desired by at least the first party. Presentation of the decrypted information to the first party can be facilitated via an electronic display.

A second party can be identified as a source of the first information transaction, and second information can be received from the first party. The second information can include a communication intended for the second party. The second information can be encrypted using a second transfer ephemeral key construction based on split values reflecting the taxonomy of the organization of interest inclusive of the first and second parties that corresponds to the intent of the access desired by the first and second parties.

A second information transaction can be generated including a second information payload. The second information payload can include a first portion and a second portion. The first portion can be encrypted using a first portion payload ephemeral key construction based on split values reflecting the taxonomy of the organization of interest inclusive of the first and second parties that corresponds to the intent of the access desired by the first and second parties. The second portion can be encrypted using a second portion payload ephemeral key construction based on split values reflecting the taxonomy of the organization of interest inclusive of the first and second parties that corresponds to the intent of the access desired by the first and second parties.

### BRIEF DESCRIPTION OF THE DRAWINGS

FIG. 1 a diagram of a Blockchain model with accompanying financial components.

FIG. 2 is a diagram of a Secure Transport Envelope.

FIG. 3 is a diagram of a Purchase Order Transaction Envelope.

FIG. 4 is a diagram of a Differential Access on a Finance Report.

FIG. 5 is a diagram of a Payment Voucher.

FIG. 6 is a diagram of a Persistent Enforcement with CKM Encryption.

FIG. 7 is a diagram of a Financial Service Components in the Blockchain.

FIG. 8 is a diagram of a Blockchain Packet Flow.

FIG. 9 is a diagram of a Distributive Ledger.

FIG. 10 is a diagram of a Information Collaboration Model.

FIG. 11 is a diagram of a Unencrypted Data Moving Through a Financial System.

FIG. 12 is a diagram of a Bank Start-Up of Information Collaboration Model.

FIG. 13 is a diagram of a Establish Supplier Online Information Collaboration Model.

FIG. 14 is a diagram of a Establish Bank Customer Information Collaboration Model Client.

FIG. 15 is a diagram of a Order Placement.

FIG. 16 is a diagram of a Process Cart Using Secure Financial Protocol.

FIG. 17 is a diagram of a Process Payment—Bank to Bank Transfer.

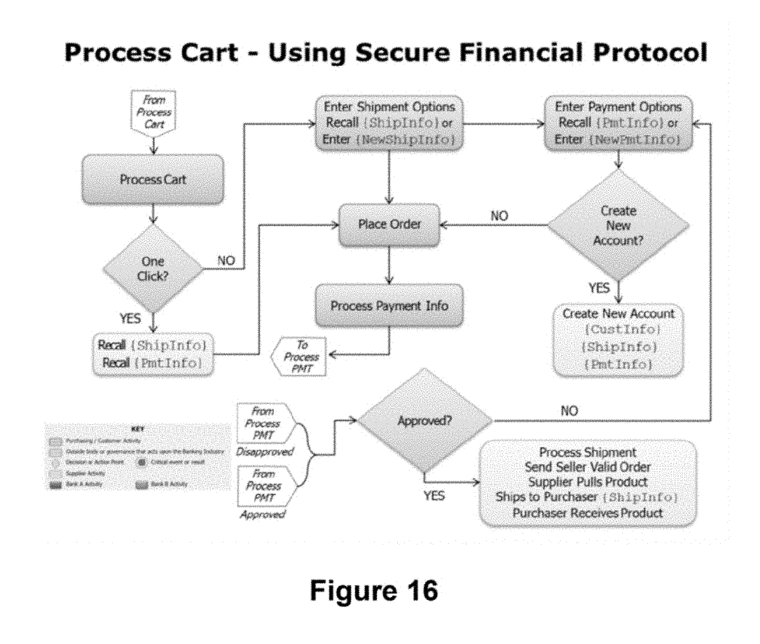

FIG. 16 is a diagram of a Enterprise Security Categories.

FIG. 19 is a diagram of a End to End Security Infrastructure.

FIG. 21 is a diagram of a Objects within a Financial Instrument.

FIG. 22 is a diagram of a Objects for Handling Currency.

FIG. 23 is a diagrams of a Identifying Features of the Dollar Bill.

### DETAILED DESCRIPTION OF THE INVENTION

### Distributive Ledger and Blockchain in Security

Building a secure Blockchain Distributive Ledger includes cryptography of the Blockchain and a defined group of Blocks or equivalent Transaction Components that constitute a financial services transaction model.

Blockchain can be defined as an encryption framework that ties components, such as financial services components, as blocks with secure linking among the blocks or components while enforcing rules of access to each of the components. Blockchain can also be expressed as a group of blocks that are linked, or chained together, in a way that the information stored in each block is secure and time-stamped. The resultant secure blocks may be distributed across a network and accessed in a Cloud.

Within the financial sector, Blockchain security technology offers an innovative method to implement financial ledgers, the records of buying and selling stocks and bonds, or just about any type of transaction. For example, a bank can track the deposits of all their customers in a ledger maintained by the bank while including other financial services such as audit and settlement that would be associated with a transaction.

As an alternative digital architecture, a ledger operation can be modeled into a distributed ledger using Blockchain technology and can establish which financial components can be absorbed outside of a bank role. Using a distributed ledger in this manner can reduce cost and have a faster payment result. However, trust, liability, and acceptance within the financial sector must be included with the Blockchain-ledger model.

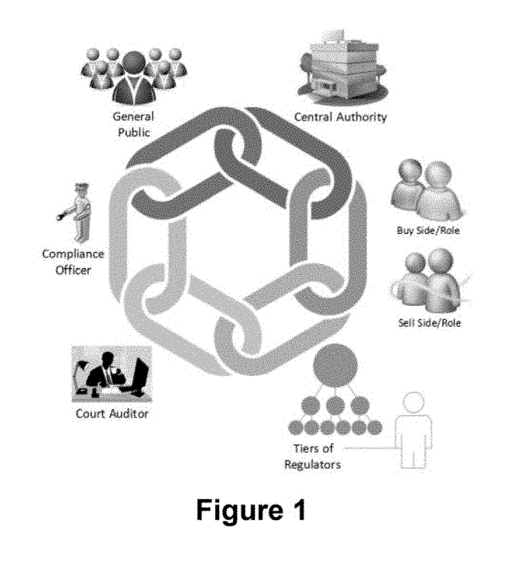

A Blockchain model with accompanying financial components is illustrated in FIG. 1. Seven Financial Services Components are identified, representing blocks that can be associated with a transaction. Major components include: Buy, Sell, Regulator, Audit/court, Compliance, Public, and Central Authority. Each component has actions that are part of a ledger process and ensure the integrity of a transaction.

Blockchain as a Secure Envelope with Identity and Encryption Enforcement

### Securing Blocks of Financial Data

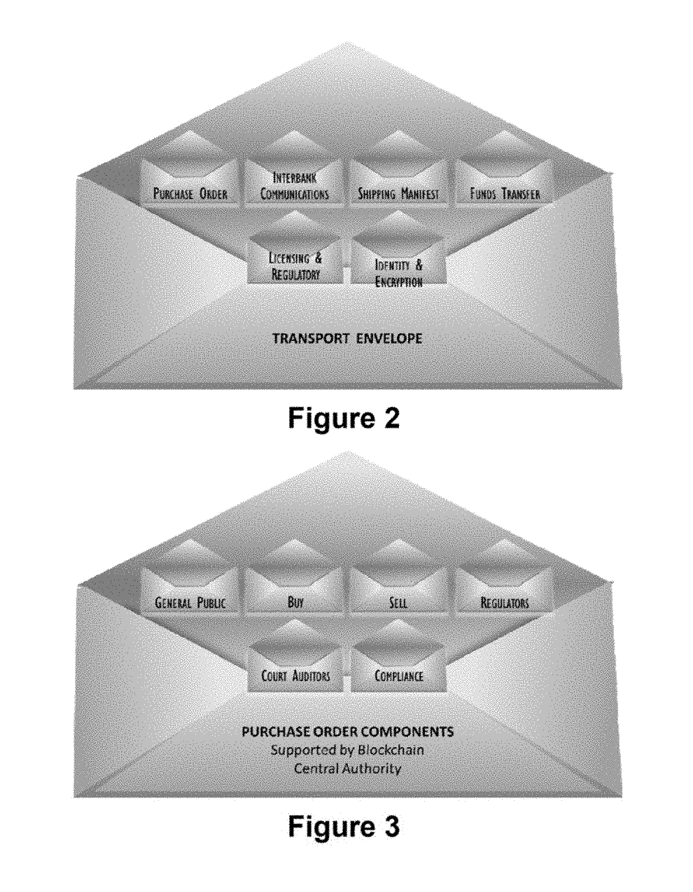

Inherent in Blockchain functionality is a capability to secure blocks of data that can be attributed to a financial transaction. Each block can be illustrated as a unique envelope, and each unique envelope, as well as the overall envelope, can be linked with a Blockchain encryption. FIG. 2 illustrates this concept.

A Secure Transaction Envelope schema includes identity and encryption for secure access control, as illustrated in FIG. 3. The intent is to front-end each financial services component (or ‘Object’) to provide authentication and authorization. For this illustration, a Purchase Order is one of the financial components. An outer envelope identified as a Transport Envelope defines a collection of financial components in which each component itself may have its own identity and encryption schema.

The following Transaction envelope contains a business application for a Purchase Order. FIG. 3 illustrates six financial components that are identified within a financial transaction. This illustration and discussion will presume that all the components are identified with current legacy financial transaction architecture and supported by a banking authority. The banking authority may be established in a different transaction authority outside of traditional bank.

Imagine that the envelopes in the previous figures are each sealed, much as sealed envelopes are circulated through our postal system. The sealed envelopes can be considered a linkage to the past when mail was a financial instrument. A sealed envelope had identity and access control defined by the Postal regulations.

A digital secure envelope can include Nested Secure Envelopes that provide further granularity to specific component actions. A sample use case can consist of a secure envelope that manages access to the various Ledger components, or a use case can be extended into a focus on one or more components within their operations while leaving other components to an access level so that proprietary or legacy applications can be applied. The legacy-encrypted envelope for a first level access may be viewed as a nested secure module in which the front-end access function is encrypted in a self-contained encrypted module and that encrypted module is applied within the main Blockchain linkage.

Now we, have a digital world that is looking to link the security of the past into security for the digital future. To relate to the digital world, an understanding of Objects is important.

Annex B provides a discussion on Defining Objects, for a Digital Currency in which the analog envelope can be defined with its objects. In the annex, the concept of objects is further linked to objects in a payment schema, finally suggesting that objects can be the starting point for identifying what security elements can be available.

### Blockchain as a Crypto Process for Differential Access

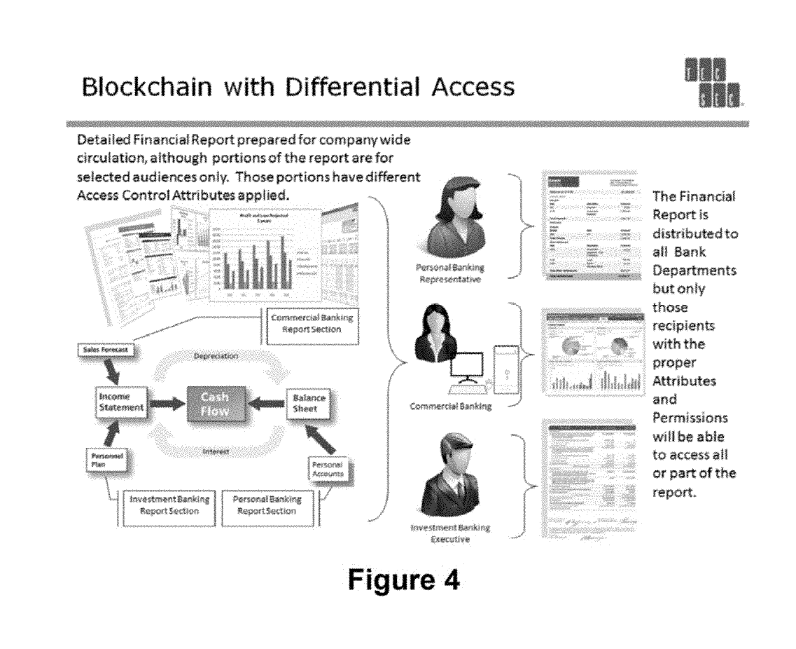

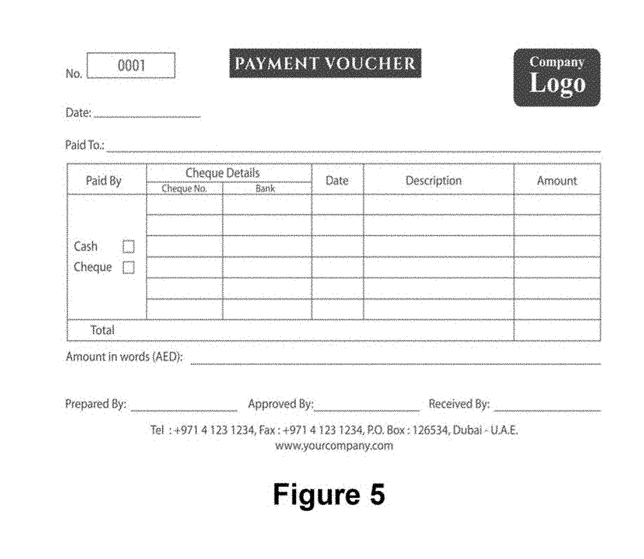

FIG. 4 is an illustration of a financial report for which differential access is applied through a cryptographic framework. The intent is to provide access to pans of the report that are needed among the various banking departments. An analogy would be a carbonless form in which sections of the form would be accessed only by authorized individuals. Looking at the exemplary payment voucher shown in FIG. 5 entries for bank and descriptions may only be accessed by a compliance officer while the voucher's other parts could be processed by others. The makeup of the voucher form would offer or require different levels of authorization.

### A Blockchain Encryption Framework

Encryption is an essential part of a Blockchain architecture. From a technical perspective, the Blockchain encryption must ensure integrity among blocks of financial components, it must encrypt the links among the blocks, and it must provide persistent enforcement for the block's content. From a functional perspective, the Blockchain encryption framework must address the following necessary actions:

Be able to handle scale,

Be able to model different encryption parameters that the financial sector defines,

Be able to integrate into the digital Internet and banking legacy architectures and

Be able to enforce privacy and liability.

A standards-based encryption schema exists as defined in ANSI x9.73, Cryptographic Message'Syntax standards, and is supported through other standards. X9.73, Annex D, details an encryption framework that results in a dynamic encryption process with a changing key for every encryption action.

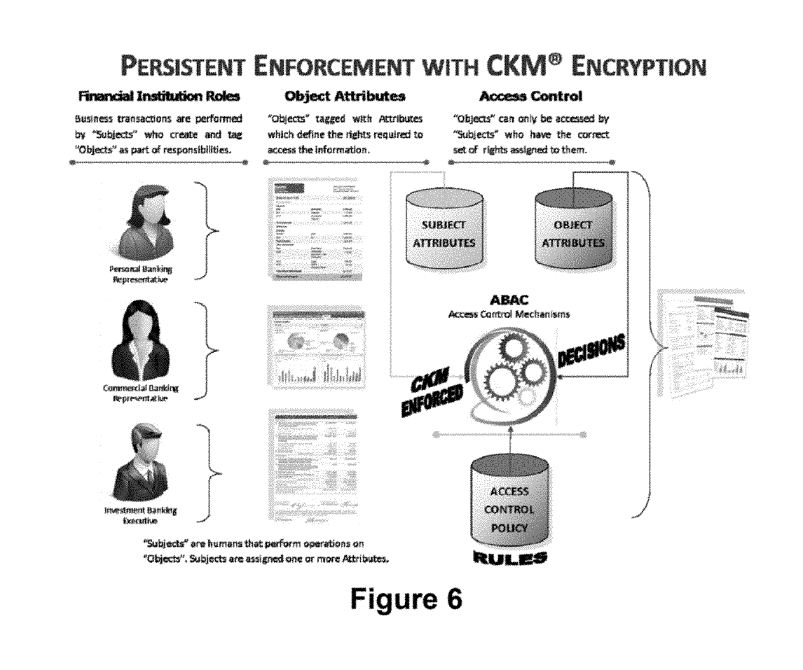

FIG. 6 is an illustration of the elements associated with the x9.73, Annex D, encryption framework identified as Constructive Key Management (CKM®). CKM encryption relates information to a mathematical encryption schema. The FIG. 6 illustration identifies key steps in the encryption process. Roles as subjects or objects are assigned responsibilities that need access enforcement. The examples in the illustration above are different representatives and personnel, but roles also can be attributed to actions within a financial institution such as a transaction's financial component access. Tied to these roles are attributes that act as the bridging agent between information and the crypto framework. The attributes define the rights required to access information associated with the roles. The execution of object access, as it relates to roles, can be further characterized in the illustration's final access control section. Note that rules for access control can be applied with the marriage of parts within the access control mechanism. The encryption becomes an enforcement agent for the rules.

The CKM process is unique, but contains standard-based algorithms that are combined to create a unique secret key. The CKM combiner can be tailored to the security level desired to protect the data. A CKM framework can provide confidentiality associated with cryptography and its secret key. Blockchain encryption needs confidentiality and the high assurance of the math association with cryptography. As a Blockchain is applied to a financial ledger, the resultant transaction and security are important to the institution that needs to measure liability and privacy. Cryptography has demonstrated an ability to be another tool for the business manager to gauge risks.

The data associated with the transaction components is included in an Encryption Envelope to ensure security integrity of a component and a security linkage within the transaction process. A naming convention is found in attributes that form a set of permissions, and these same attributes include math that is bound to the CKM encryption schema. The Central Authority component may be a bank or other financial services entity and is responsible for managing the encryption. The CKM encryption framework includes a standards-based random number that changes with each cryptographic event to ensure integrity for the encryption process.

### Permissions as Enforcement Attributes

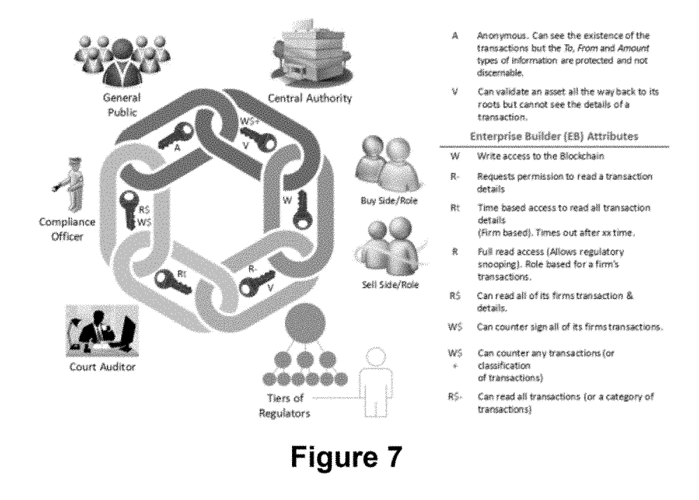

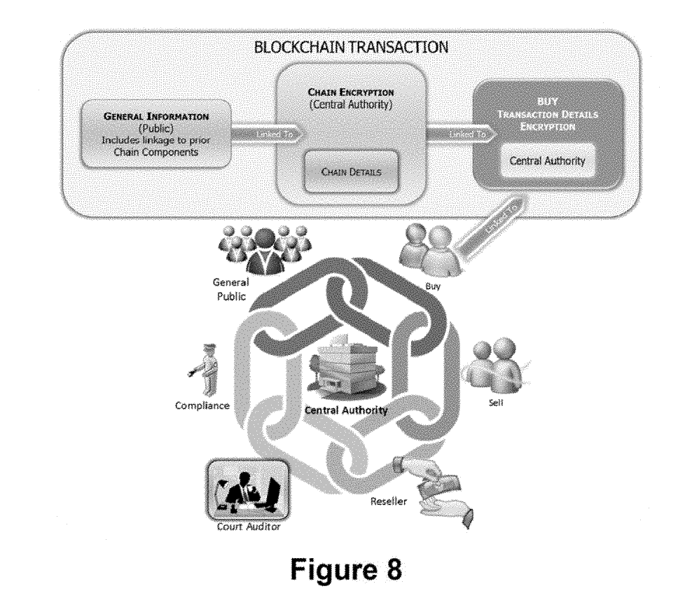

The CKM framework includes attributes that define access to the encryption envelopes associated with the transaction component actions. The permissions allow different levels of access. FIG. 7 includes a sample representation of financial component actions associated with permission attributes.

### Attribute Listing for Financial Services Components

The following is a sample attribute listing for the major financial services components. It is possible to add attributes to the list based on the desired extent of granularity and extent of connectivity within each component's specific application or module.

TABLE 1
Financial Service Components

| Component | Attribute | Usage |
|---|---|---|
| Central Authority (EB) | PlainTrans | Anonymous. No details of To, From, and Amount |
| Central Authority (EB) | BankAuth | Share transaction data with other financial |
| | | institutions. Read or Write encryption authority exists |
| Buyer (Purchaser) | Buyer | An entity who or which has funds to buy goods |
| Seller (Supplier) | Suppler | An entity that has goods to sell |
| Regulator | Regulator | May be limited to Read Only or, Buyer’s Read Only, |
| | | for a specific transaction part |
| Court Auditors | Court | Access level determined by Central Authority (Each |
| | | financial institution has established its policy to work |
| | | with compliance) - Read, Write, or Full access |
| | | options |
| Compliance | Compliance | Access level determined by Central Authority (each |
| | | financial institutions has established its policy to |
| | | work with compliance) - Read, Write, or Full access |
| | | options |
| High Net Worth Entity | HighNet | To identify a high net worth person or entity |
| Application Access | AppAccess | Front end linkage to financial services components |
| Control | | using encryption |

Background Material Associated with Financial Services Components and Attributes

The following alpha indicators are seen in the Blockchain transaction shown in FIG. 7:

“A” says that the existence of a transaction is visible to anyone, but the To, From, and Amount types of information are protected and not discernible. There may be instances in which the amount is not protected. Central Authority has an enterprise key manager that controls the creation and distribution of all attributes related to the creation and validation of the chain.

“W” and “V” are actually the read write components of an attribute for the Blockchain itself.

The other R's and W's are provided by an enterprise key manager that is controlled by the firm, group, or person to which, an account in the Blockchain is assigned.

A record in the chain has a portion encrypted using “W”. The transaction details (From and To) are separately encrypted using the Firm's Attributes in any mix as appropriate for that type of transaction (determined by the firm). This provides a form of protected identity, anonymous to the outside world but visible for internal tracking, auditing, and regulatory issues.

Shares can be issued from either or both of the Central Authority and a Firm's enterprise key manager to allow for the read of the required level of details by courts/auditors/regulators.

The encryptions can be bound together cryptographically.

TABLE 2
Financial Service Component and Access Permissions

| Component | |
|---|---|
| Person/Role | Description/means of access through Attribute Permissions |
| Central Authority | The Central Authority holds an EB that controls the creation and |
| | distribution of all attributes related to the creation and validation of the |
| | chain. Manages the overall Blockchain and has the “V” and “W” |
| | components. The Central Authority issues the “W” component to each |
| | player that has the ability to create transactions. Note there may be |
| | multiple “V” and “W” components for different types of |
| | customers/transaction sizes. |
| Buyer/Seller | Has firm-based attributes so that they can create/read the details of a |
| | transaction. This can become a web of relationships between a buyer |
| | and the sellers from whom they purchase items. The buyer initiates the |
| | transaction as they are transferring money from their account to the |
| | appropriate seller. The seller may or may not have the ability to read |
| | the buyer's details. The transaction itself would have a unique identifier |
| | that the seller could internally link to their own records. If the buyer |
| | works with a seller a lot, then they COULD grant the seller the “R” |
| | portion of the attributes for the Transaction Detail records from that |
| | buyer to that seller. The buyer could use any combination of internal |
| | attributes also for the firm's internal book-keeping and processes. |
| Regulators | Regulators can have a variety of needs. Sometimes they would just |
| | need to validate the integrity of the transactions. In that case, the |
| | Central Authority would grant them the “V” component for the |
| | transactions in question. Other times they need more transaction |
| | details. In this case, the Firm's (buyers) would either grant read access |
| | to the transactions or issue “Shares” for the particular transactions in |
| | question. |
| Court Auditors | This role is very similar to the Regulators. It is more likely however that |
| | both the Central Authority and the Firm would issue “Shares” for the |
| | exact transactions in question. |
| Compliance Officer | This person would be issued the read attributes from the Firm and |
| | possibly also the write attributes. |
| General Public | The general public would not be issued any attributes from either the |
| | firm or the Central Authority. They could only see that the transaction |
| | exists and the public information in the transaction. |

### A Secure Packet Based on a CKM Header and Linkage to Transaction Details

An overall high-level view of an exemplary Blockchain packet flow is illustrated in FIG. 8. The Blockchain illustrated in FIG. 7 is presented as a set of financial component blocks that are chained together with to-and-from links bound by the crypto attributes of the Central Authority. One of the components, the BUY component, is further detailed in FIG. 8. The basic architecture would be applied to other components to complete the linkage among the financial components.

Further content protection can be included within each component using the same architecture, but the protocols to embed the Blockchain mechanics may differ.

### Blockchain Usages

To explore usages for Blockchain and accompanying ledgers, there are sues and directions that need be included as decision factors.

1. Blockchain encryption can, eventually become a means to alter existing financial services infrastructure, but not by itself. Blockchain needs to take into account the Internet (or other network), Identity & Data Protection, and Legal guidelines.

2. From an alternate view, access to the data must include authentication and authorization security techniques.

3. Employing Objects to define the data:

Objects to facilitate processes associated with manipulating the data,

Objects can be the basis to define the Blockchain encryption engine,

Objects to establish an encryption framework that binds encryption to the data directly, and

Objects that include a framework,mechanism for attribute permissions to manage access to the data.

4. Secure objects allow the access controls for its content to be integrated with the object; regardless of where the object is stored, the data is secured.

5. The Blockchain encryption framework needs to accommodate a mix of cryptographic encryption algorithms to accommodate international usage.

6. Each object encryption action results in a new encryption key. A compromise of that one key limits access to that one key's data. Subsequent data encryptions use new and unique encryption keys.

7. Existing standards have the integral security elements needed for a Blockchain encryption and Distributive Ledger architecture.

8. An exemplary object oriented encryption framework is defined in ANSI x9.73 and ANSI x9.69 a dynamic encryption syntax identified as Constructive Key Management.

9. The ledger may be public or proprietary. A proprietary ledger includes Identity as an essential differentiator. The intent of the Public ledger is to allow financial inclusion without access to existing financial services (unbanked, underbanked, and unbankable).

10. With cryptography, National and International export controls must be considered.

11. The Blockchain-Ledger schema must be able to accommodate new advances in cryptography, in communications, and in Internet protocols.

12. Identity and authentication may be considered as fixed to an individual or to an entity; whereas authorizations are changing to definitive access requirements relating to financial services.

13. Secure yet configurable access is applied to varying levels of sensitive data.

14. The fixed Identity design must be able to be movable to accommodate the potential different data access authorizations.

15. Codified business processes can't be skipped because of the mathematical steps associated with the Blockchain schema, and because of the Blockchain blocks which are linked as secure data envelopes.

16. The Blockchain block linking provides integrity to the regulatory and compliance steps.

17. The schema needs to accommodate levels of Privacy and Liability to match various financial services' needs.

18. The Blockchain encryption can secure smart contracts that are object oriented.

19. Tying financial identifiers for assets to Blockchain permissions creates a forensic trail to help prevent the same asset from fraudulently use for multiple different instruments and business uses.

20. A secure transaction model includes several essential financial components as previously identified The Blockchain encryption and Distributive Ledger can provide a security mechanism to link the financial block components as secure containers with unique legacy or open actions.

### A Sample Object Oriented Secure Blockchain and Distributive Ledger Architecture

The following illustrations are a collection of activities associated with a Blockchain and Distributive Ledger. Different security entities are being presented to create an overall object of multiple-layer accesses leading to an abbreviated sample transaction.

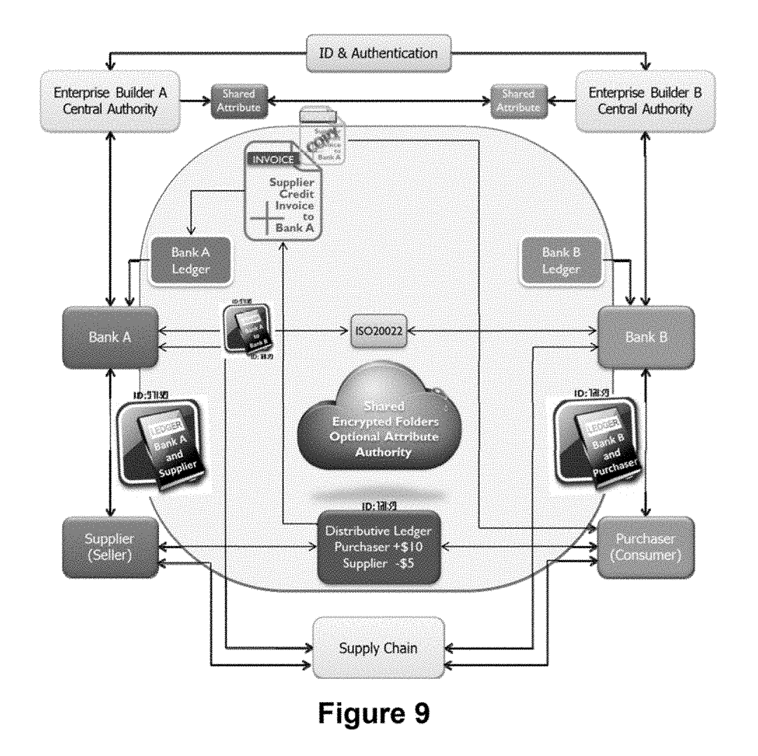

FIG. 9, which begins with Bank A options for Identity elements that are the basis of an encryption process that results in an e-Profile secure envelope, which in itself contains sensitive information associated with protecting the Transaction. It should be noted that a Transaction process is only one of many different financial services and other market usages for an e-Profile secure envelope. In the context of a financial services transaction, selected financial transaction components with their access attributes and other sensitive processes, like building an encryption key on the fly, is contained in the secure envelope. The financial components are a series of Blockchain blocks of data that are linked to a transaction. The inherent linkage is effectuated with cryptography and other identity markings associated with accepted financial services practice.

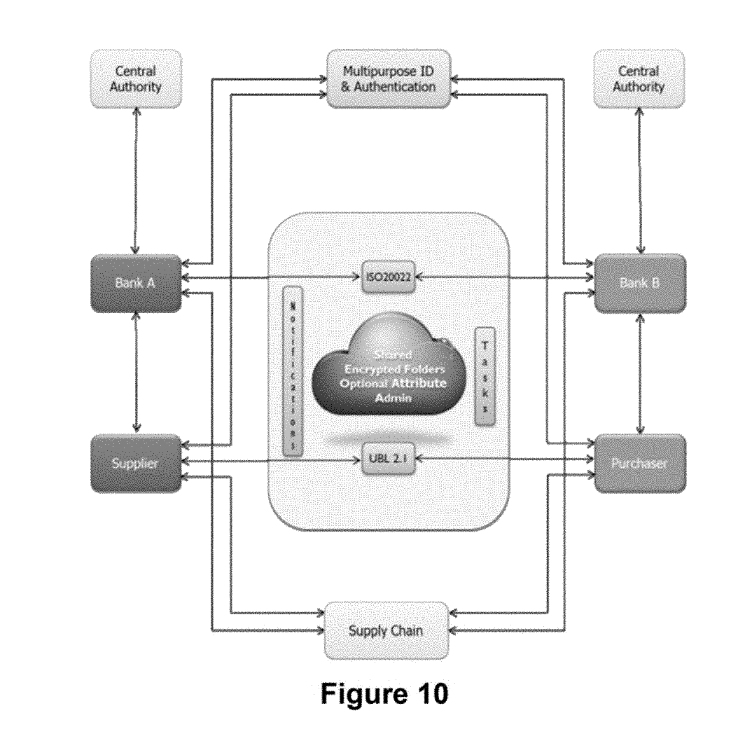

FIG. 10 shows an Information Collaboration Model. The model includes, access attributes associated with an encryption framework like Constructive Key Management with an assignment of a designated attribute for each of the identified financial components, as well as an attribute for sharing data with a central key management authority. The Central Authority man ages the attributes in the form of secret keys and distributes the keys with Push architecture. Other functionality exists with the Central Authority, like key maintenance and other standard-based functionalities for key management In this illustration, the Central Authority is maintained by a bank. Two banks will be portrayed in support of a seller supported by one bank and of a buyer supported by another bank. At this level of the sample model there are components representing compliance, audit—legal, regulator, a high net worth entity, the Buy, and the Seller. All these components are included in the current financial services use case. The communications and content technologies associated with this security architecture can change and result in a determination of which financial components are needed.

The model continues with another level of abstraction associated with the potential content of each of the financial components. An access attribute was assigned to offer access to the designated component (in this illustration) Attribute 1 offers access to the BUY component). The BUY component consists of Public data, Chain details, and Transaction encryption details. The Attribute 1 is the key associated with the encrypted BUY block which includes a mix of open Public data and the necessary information pieces to decrypt the block and do other actions associated with the BUY component.

A cryptographic access capability for different access points in the overall Blockchain schema is included. The associated cryptographic engine can segregate access for a read or write or both access. This level of capability establishes differential access to a common set of information. A file could be accessed by content restriction to different persons or machines based on its access permissions through attributes. Defining these attributes are policies associated with the owner of the Central Authority Encryption administration.

Bank B is introduced into the collaborative model to cite multiple banks' applications that are associated with the Purchaser. Like Bank A, Bank B provides services to ensure the integrity of a transaction. The secure linkages and encryption of a Blockchain also ensures a chain of custody with regulatory, audit, and compliance validations.

The architecture has flexibility to structure the model so that existing legacy systems are accommodated while the object oriented block architecture can be adjusted to accommodate new ways of doing financial services.

### Building a Secure Transaction Model

A Use Case is illustrated in FIG. 9 in which a generic transaction takes place between a Supplier and a Purchaser with a separate bank supporting each of the two participant financial services components. The Permissioned Blockchain model of FIG. 7 (Financial Service Components in the Blockchain) is modified and illustrated as a more detailed secure overview Distributive Ledger with Blockchain linkage. Limited details are included for the invoice, and for the potential use of the ISO 20022 payment schema, (Other payment schema could apply).

A transaction can consist of two banks (Bank A and Bank B), which manage the financial accounts and related ledgers for a Supplier (Seller) and for a Purchaser (Consumer). A fifth entry can be included for a merchant, but the basic model would be the same. The flow for the transaction is cited in the central authority model in which the two banks establish Purchaser identities respectively and manage banking like today's implementations. A bank ledger exists for each bank as they relate to their respective customer, and the ledger is available on a demand basis. In the transaction flow with attributes from Bank 1 and Bank 2, each bank would have own its separate CKM attribute access administration (Bank A Enterprise Builder and Bank B Enterprise Builder). To share attributes in this model, a Bank must share one of their attributes to others to maintain a secure sharing of data. (The encryption administration model includes a consideration for liability associated with managing access to the data. The example identifies two banks that would have their own administrative responsibilities. The encryption administration may be shifted to other entities other than a bank, but such an action would have to consider the liability ownership associated with the data).

A Distributive Ledger model has the same transaction taking place but with a different security schema which includes a hybrid-CKM Blockchain capability identified in ANSI x9.73, CMS, and can be related to an object-oriented protection encryption process. To do the hybrid-Blockchain capability, CKM includes a function within the CKM Combiner that can be, applied to subsequent chaining actions among a transaction data flow of multiple points. In the FIG. 9 example, example the Purchaser wants to purchase an item from the Supplier and the Supplier needs to validate that the Purchaser has sufficient funds to pay for the item. A Distributive Ledger is established and executed among the multiple transaction points. The example model has Bank B creating an agreed Ledger with the Purchaser. (The Bank B ledger would include a unique number or identity in order to attribute the ledger to Bank B and associate it with the Purchaser. The Bank B ledger would also include the amount of available funding for the Purchaser. Bank B shares the ledger with the Purchaser who now can attest that funds are available for a purchase. The Purchaser contacts the Supplier to purchase the item with funds identified in the purchaser ledger. An example can be that the purchaser begins a ledger with a $10 amount before forwarding to a supplier. The supplier deducts the amount of the purchase against the Purchaser ledger. As an example, a $5 deduction is applied against the original ledger. An encrypted Supplier invoice is created that includes internal and header data, as well as the original transaction number. The action continues with the Supplier forwarding the annotated ledger to Bank A for credit to the Supplier account, and copy of the encrypted invoice to the Purchaser for transaction receipt. The Purchaser decrypts the Supplier header only, because the Purchaser would not have access to the Bank A/Suppler access attributes to decrypt the invoice (which could also contain additional Supplier proprietary data) that was also sent to Bank. A. Bank A forwards the annotated ledger to Bank B to deduct the amount against the Purchaser account. It should be noted there can be variations on the transaction model but the core concept would apply. To enforce the transaction cash flaw and purchase flow while preventing a third-party manipulation of the data, a hybrid-CKM Blockchain model can be applied. Header validation and access control can extend from hash, a keyed hash, or an encryption framework that is identified in ANSI x9.73, CMS.

A Distributive Ledger is used by the Purchaser that identifies a validated cash amount that the Purchaser can apply against purchases, (the mechanics for establishing what the Purchaser would want to publish in a ledger may vary with policy and execution). The data associated with the ledger at this stage would be encrypted with CKM enforcement. Elements of the encryption that relate to the ledger encryption process include attributes that are associated with Bank B and the Purchaser, and a unique number for the Purchaser ledger. That ledger number would stay with the total transaction flow and be a cryptographic assurance binding for the process. (The unique number would be included within the CKM internal process to further add security integrity.) The encrypted Purchaser ledger number is also included in a partially encrypted Header that is part of the initial encrypted Purchaser ledger. The encrypted Purchaser ledger data includes the ledger number, the available cash amount, and other data—this becomes the first encryption step in a distributed ledger process. The encrypted Purchaser ledger is forwarded to the Supplier, who decrypts the Purchaser Ledger Header and notes the confirmation of the amount available from the purchaser and the transaction's unique number. A point to consider is that the Distributive Ledger secure process may include an external identity capability as an adjunct to the CKM enforcement, or may be limited to the transaction number and URL of the Purchaser for a cash-like transaction. The next step in the Distributed Ledger process is for the Supplier to get credit for the transaction by forwarding the original encrypted Purchaser ledger with its CKM enforcement Header, which is encrypted with the Supplier CKM attributes and the purchaser unique identity number; the resultant. Supplier Header with the encryption includes the plaintext original identity number and the Supplier's transaction cost. The double-secure encryption-wrapped transaction is used by Bank A to credit the Supplier account by decrypting the Supplier CKM-Header to establish the credited amount. Bank A confirms the transaction and settles the $5 debit against the Purchaser account with a Bank A encryption of the multiple encrypted Distributed Ledger originated with the Purchaser and continuing through the secure transaction process.

A two-or-more bank model approximates existing financial services. A faster transaction model could leverage fewer entries beyond the Purchaser and Supplier entries. However, to accommodate the existing regulatory financial transaction infrastructure, several other financial services components must be considered beyond the Central Authority component of a bank, the Purchaser component, and the Seller component. The Regulators the Auditors, and Compliance components complete the transaction process.

The Distributed Ledger is a digital form of a financial transaction. The encryption process is a digital form. Identity may be a mixed of analog and digital functionalities. The partially encrypted CKM Header offers a performance advantage to track the transaction while including encryption—the encrypted ledger does not have to be decrypted during the transaction processes but its encrypted data provides a multiple-step access that can be validated by a third party with proper access encryption attributes. Only a bank in this example can provide the proper access encryption attributes. Fraud is minimized because the encrypted transaction requires access through two levels of decryption—one decryption for the header associated with an entity's action and one decryption for the transaction ledger. The amount identified in the header must match the encrypted amount contained in the Ledger. A Compliance CKM attribute can be added to each encryption step in the secure transaction—the attribute would be unique to a compliance action and be managed by the compliance entity for a third-party validation.

A faster payment transaction may take a different form of a distributive ledger in that the object-oriented protection encryption schema can create a security state that permits an extended time before a transaction needs validation. The current security validation per transaction event adds time to a transaction validation. Validation between the two banks of the above transaction process for each transaction adds a defined time to a Distributive Ledger model. A minimum time frame can be established between two parties to a transaction: the purchaser and the seller However, both parties want an assurance that funding is available for a purchase, and that the funding can be captured by the seller. With the addition of a CKM object-oriented framework, Bank B of the Purchaser establishes a certified account that the purchaser can draw against. At that point, the Purchaser has a defined amount of currency to apply for use. For example, the Purchaser establishes a transaction with the seller to buy pencils. Like the generic transaction model, the action of the seller is the same. A seller invoice is created identifying the amount deducted from the purchaser's currency/consumer Ledger and forwarded to the seller's Bank A and the Purchaser. The purchaser knows that the seller will be sending his pencils and has deducted the money from the certified Purchaser's ledger. The bank-to-bank reconciliation of this transaction would not be, performed at this time but established by policy (agreed upon of how often should a collection of transactions be validated between banks). By having an encryption overlay at the data object level, and having an encryption hybrid-blockchain in the transaction process, the bank-to-bank reconciliation may be extended for several days. The result is to increase to a faster payment—transaction process without compromising security and maintaining legacy systems to the extent possible.

### Details of a Secure Blockchain Distributive Ledger Use Case

### A Secure Cloud Environment

Financial Services are using various communications channels such as the Internet and private rails to execute transactions and payments. Other services are also available through these channels.

Collaboration, information sharing, and anywhere, anytime, anyplace, any-device access to information are all terms discussed daily by companies as they try to find ways to increase efficiencies, cut costs, and effectively exchange critical-business information with their trading partners, suppliers, employees, and extended value chain.

In addition to the financial services communications channels and the information sought by companies, cloud services are commonly used. These security services must include technical controls for encryption of data at rest and of data in transit, and other data audit-handling compliance requirements. Compliance may call for specific levels and granularities of audit logging, and other financial security components are also present, such as legal (court) and regulatory components. These components can result in the, generation of alerts, activity reporting, and data retention. As an example, a data owner that subscribes to a cloud has provided its own data assurance or has contracted for an identified level of data assurance protection. The cloud may be viewed as a meeting place for collaboration and not just a storage service.

### A Sample Online Cloud Access Control Use Case Enforced by Encryption

The use case is an online cloud model like a cloud service that can do full trading partner participation for a supplier and purchaser and their banks, as shown in FIG. 10. A Supply Chain is identified to accommodate the logistics associated with the sale of material.

To reach a broad participation with the overall capability, the cloud services could provide a range of support for file and message services with selective encryption service. Granular access and granular protection may be the goal for the files and messages that can be shared among participating banks and the participating supplier and purchaser. A hierarchical folder structure could be used for organizing information, including information that has been encrypted. Applying a shared folder space between two collaborating parties, content sharing is possible through the metadata of the encrypted information. The shared folder may be considered similar to a publish/subscribe metaphor. Once the use case for information storage and sharing is established, the encryption process could be applied to an Attribute at the data or message level as described in ANSI x9.73 CMS for Constructive Key Management.

Attributes may be identified with roles or with rules in the context of access control with encryption enforcement. The encryption split key associated with an attribute needs to be held confidential, but the attribute nomenclature may be identified in the public domain. (An exception could be if Traffic Analysis requires both the encryption split key and the associated attribute nomenclature be confidential.) The attribute nomenclature may, be identified within an application by limiting the attribute to a numbered content identity reference aligned from a financial services attribute listing, or, the attributes may be identified by the attribute nomenclature from a financial service attribute listing.

Mathematically, a Boolean logic relationship can be established between Attributes, such as a Logic OR or a Logic AND.

A Logic OR would have either Attribute for two attributes applicable, whereas a Logic AND Would require both attributes.

A Logic OR may be considered as expanding access control, whereas, a Logic AND may be considered as contracting access control.

TABLE 3
Attribute Labeling
A Use Case Sample Label/Attribute/Attribute Listing

| | |
|---|---|
| Purchaser | Attribute 1 |
| Supplier | Attribute 2 |
| High Net Worth Entry | Attribute 3 |
| Compliance | Attribute 4 |
| Application Access Control | Attribute 5 |
| Regulator | Attribute 6 |
| Auditor | Attribute 7 |

The management of the attributes and other encryption parts is performed by a Central Authority. The Central Authority, in this use case, is controlled by the banks. The Central Authority may be financial services that a bank or other financial service entity licenses.

To begin as a transaction example, consider an event for a given Folder based on an invoice and a transaction. If a customer has created a payment folder and associated a service-provided payment policy to it, the user can drag a newly arrived invoice into the Payment folder, resulting in an event that would be propagated to the payment service. The payment service would retrieve the invoice and transform it into an XML payment document. The payment service would then send the payment document to the bank for transferring the appropriate funds to the supplier company that generated the invoice. Identity policy and components can be established for each bank. Further digital logic can be applied to align the collaboration process to a financial services business case.

Metadata descriptors are important for sharing and establishing secure access. The metadata packet was discussed previously. Access policies are an integral part of the information itself and travel with the information in such a manner that information can be present anywhere, anytime, anyplace, and on any-device. Moreover, protecting the data ensures confidentiality of the information being exchanged between two or more collaborating entities. Role- or rule-based control can establish a conformance to the information flow that, was intended through the hierarchical folders.

The supplier and the purchaser must have an appropriate encryption keying material. Establishing a model for sharing data once encrypted is performed using an attribute administration. When establishing the hierarchical folders, CKM encryption attributes are established based on information identity criteria found in the financial service attribute listing. Identity can be established through roles, rules, and other characteristics for classifying information or data. Additional identities can be established as a separate process of multiple purpose ID and authentication with an Identity Security model as previously discussed. These attributes come with CKM keying material and have a key management framework to comply with other ANSI and cryptographic handling standards.

The encryption schema of metadata and encrypted data can be viewed as an object container that can include additional object containers to provide distributive compartmented separation of secure information access within a common file or common message. Encrypted/coded data can be displayed as redacted information in a usable format. Secure containers can be established for selected financial service components and nested as an independent secure container within a Blockchain object container linking the containers with nesting. With a mix of attributes that are different among the object containers, a single object container can have selective access for different financial components or further granularity with segments of information such as tiered access to pieces of invoice data—the multi-carbon paper used in the past left different levels of access for a paper solution. The object container can be viewed as a digital representation of this model.

Encryption key components for protecting the content in this use case can be directly aligned with information control dictates. Because the key components are directly associated with information control such as roles or rules, it may be the case that only a few key components are needed. The resultant encrypting keys, for which the key components are in part, include a random capability to ensure that each encryption message or encrypted information is unique and protected. The key management administration maintains the distribution and integrity of the component keys and other criteria supporting the encryption framework.

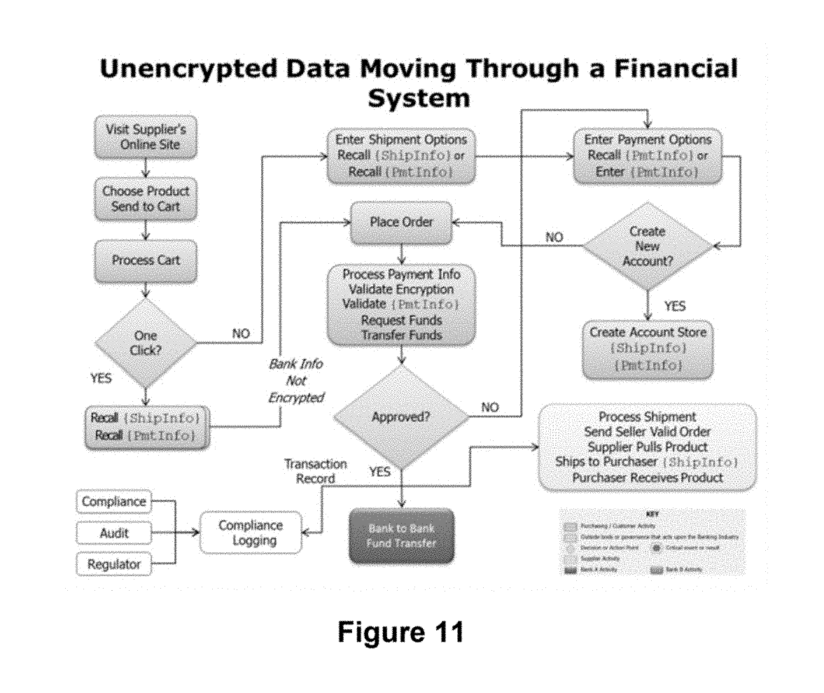

FIG. 11 illustrates the basic collaboration entities that can be related to a simple supplier and purchaser exchange and transaction (additional actions are possible):

Purchaser requests pencils from Supplier

Supplier confirms with invoice to Purchaser

Purchaser pays invoice through its Bank B

Bank B confirms payment with Supplier Bank A

Bank A confirms with Supplier that funds are available

Supplier sends pencils and confirms transaction

The following is a sample Attribute exchange example among Purchaser, Supplier, Bank A, and Bank B:

Bank B issues Attribute 1 between Bank B and Purchaser

Bank B exchanges Attribute 1 to Bank A to establish use with Supplier (sensitivity and/or privacy of Purchaser has established a need to protect details for purchase and transaction details)

Bank A establishes a crypto relationship between Bank A and Supplier with Attribute 2, and exchanges Attribute 2 with Bank B. (The Supplier Attribute 2 can be used to protect details of the invoice).

A transaction confirmation can be achieved by combining Attribute 1 with a logic AND to Attribute 2.

The Purchaser may be considered a high net worth entry and have a separate Attribute 3 to further protect its identity and/or privacy during a transaction.

A company may have a compliance rule application for which the company would want to maintain usage with encryption enforcement through Attribute 4.

Encryption can be used to provide enforcement to a component application or a component message within a container-like message with Attribute 5.

To complement the collaboration process, an example of a financial services messaging exchange process through ISO 20022 (or other payment schema) and the Universal Business Language (UBL) for a supply chain interchange can be included. XML is a coding schema for ISO 20022.

ISO 20022 messages are available far complete end-to-end payments chain:

Customer-to-bank (payment)

Bank-to-bank (payment clearing and settlement)

Reporting (cash management)

The messages can be encrypted with the access controls and Attributes identified previously.

ISO 20022, UBL, and XML are examples presented only to, illustrate a financial service's payments architecture, and other payment schema may be used with the encryption.

### Secure Payment Transaction Process

### Overview of an Information Collaboration Model

The banking industry has a reliable, robust financial transaction transport infrastructure in place. Protection of the transaction process relies upon trusted connections among suppliers, purchasers, and banks. Spectacularly successful attacks are perpetrated against these primary data stores simply because sitting there, unprotected, rests the high-value return on investment treasure.

The flow of financial data through the transport infrastructure has experienced attacks centered on denial of service more than data theft. It is only a matter of time before data traversing the financial infrastructure will increasingly become the focus of possibly undetectable siphoning.

The advantages of an information collaboration model to cryptographic enforcement of policy and data protection is derived from encrypting the data package without modification to the transport infrastructure or data headers. This approach makes the mechanism independent of transport protocols and provides low to no impact on data infrastructure legacy investments. Financial transactions between entities have the data package wrapped with unique encryption attributes known only to the entities involved. These can only be decrypted by those entities in the transaction path that have shared attributes, thereby achieving a mechanism of persistent data binding to identity and authorization attributes, seamlessly maintained from initialization to storage.

The information collaboration model standards-based technology is applicable to the banking industry for protecting financial transaction and data storage. The bank's existing services are enhanced by the addition of the model. The model enables the use of cryptographic attributes created and controlled by the bank to complement unique Identity and Authorization (I&A) capabilities for the bank and its customer. It is possible for the customer's attribute be embedded in a bank card given to the customer and applied through the model's protocols to all, customer account data as it is created and stored. Using a single persistent protection schema, banks, customers, and their data are protected from compromise during the transit and storage of sensitive financial data Should compromise be accomplished, the attacker's access is confined to one individual account, having compromised only that customer's unique attribute key protecting their data. The intent is for no data breach of he institution's entire data store to be possible.

The same model's technology can also be used for Bank-to-Bank financial transfers.

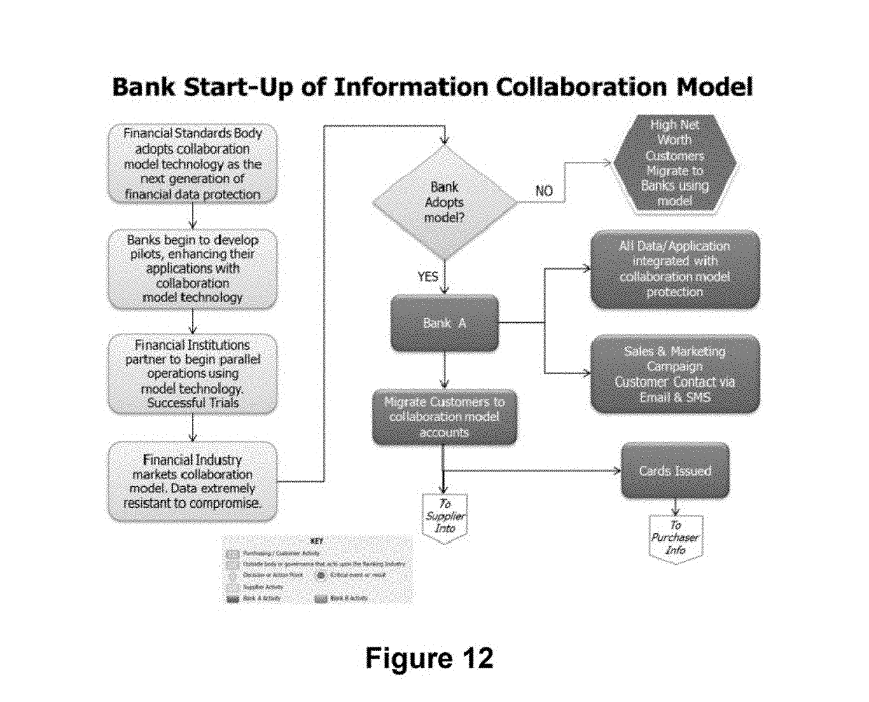

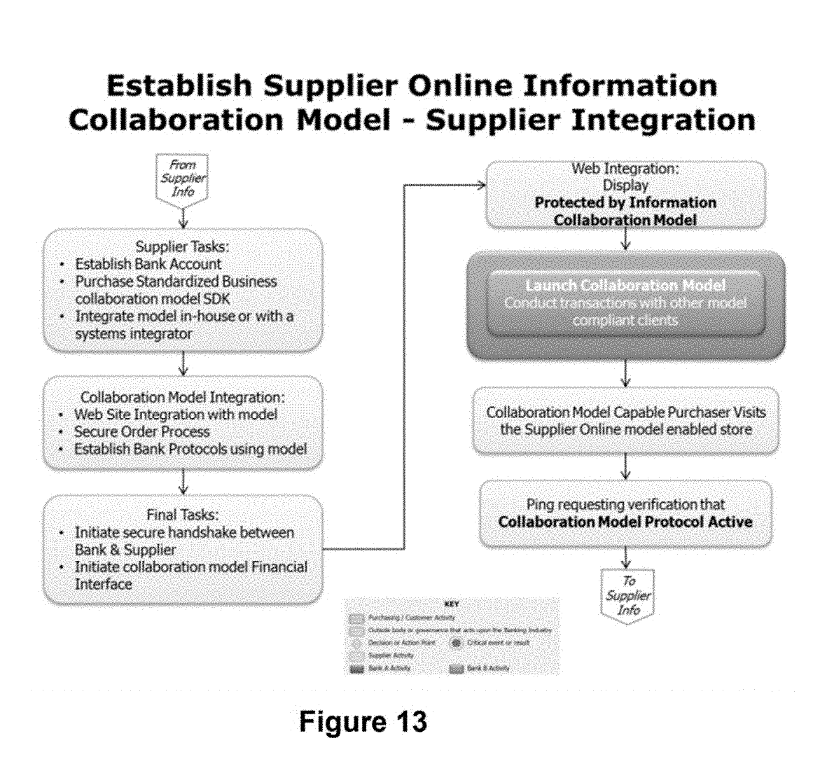

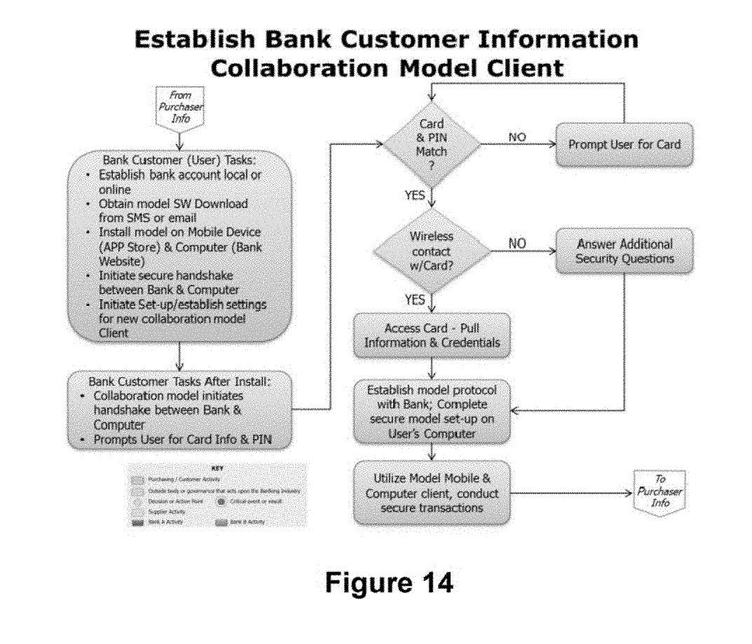

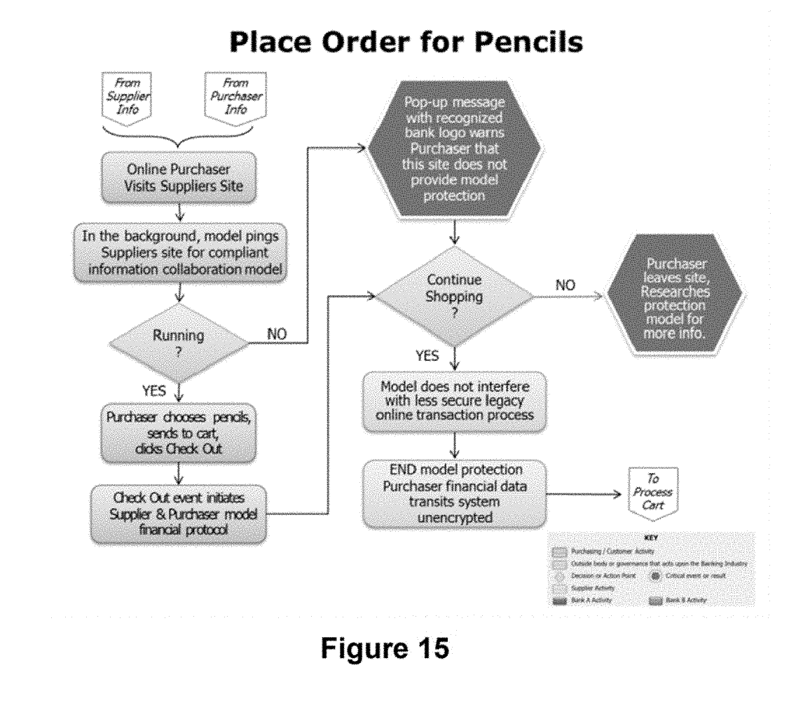

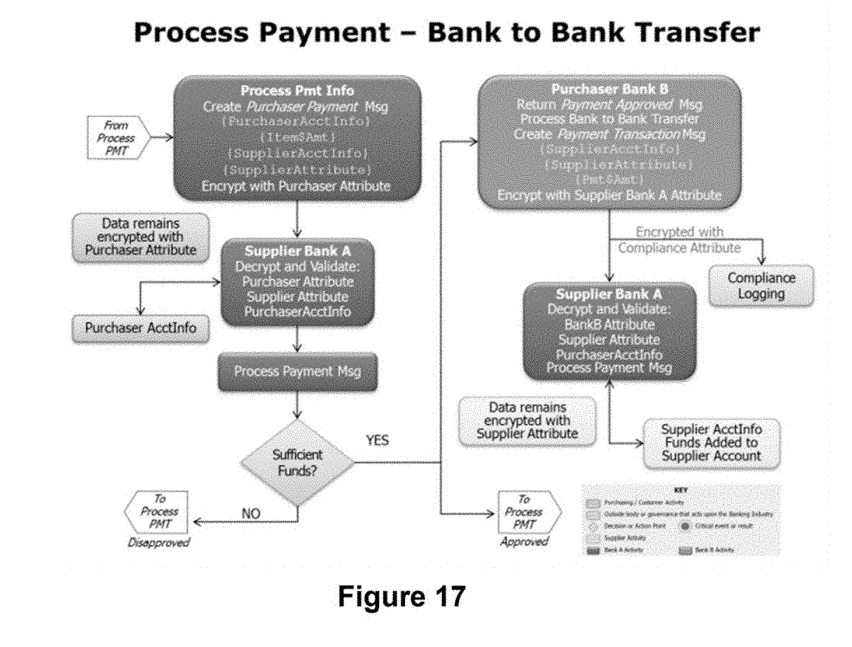

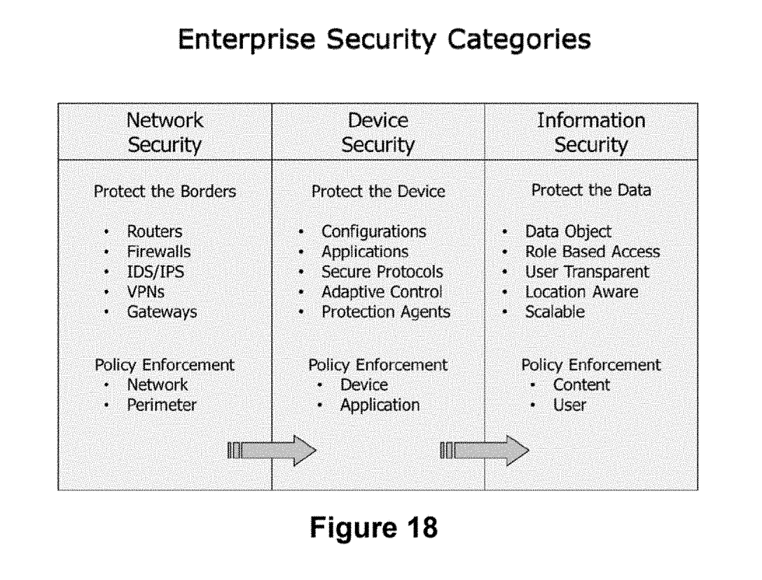

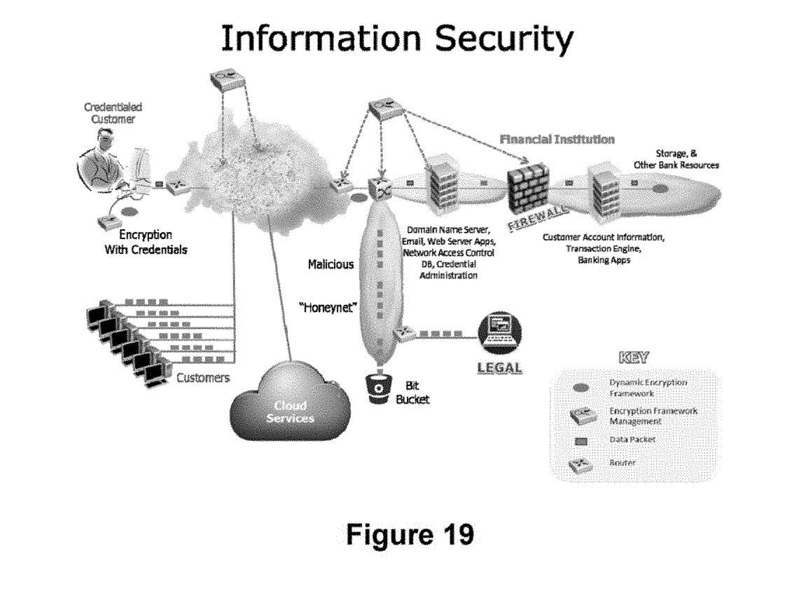

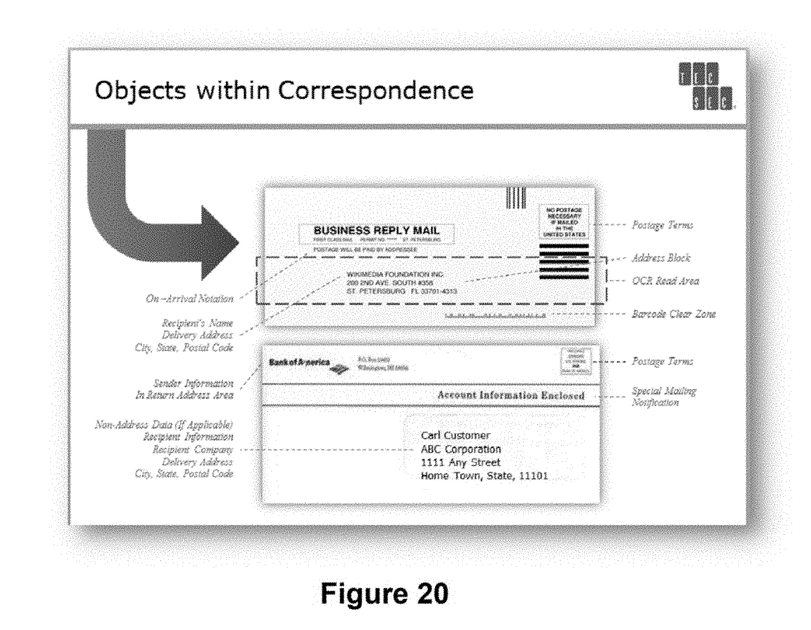

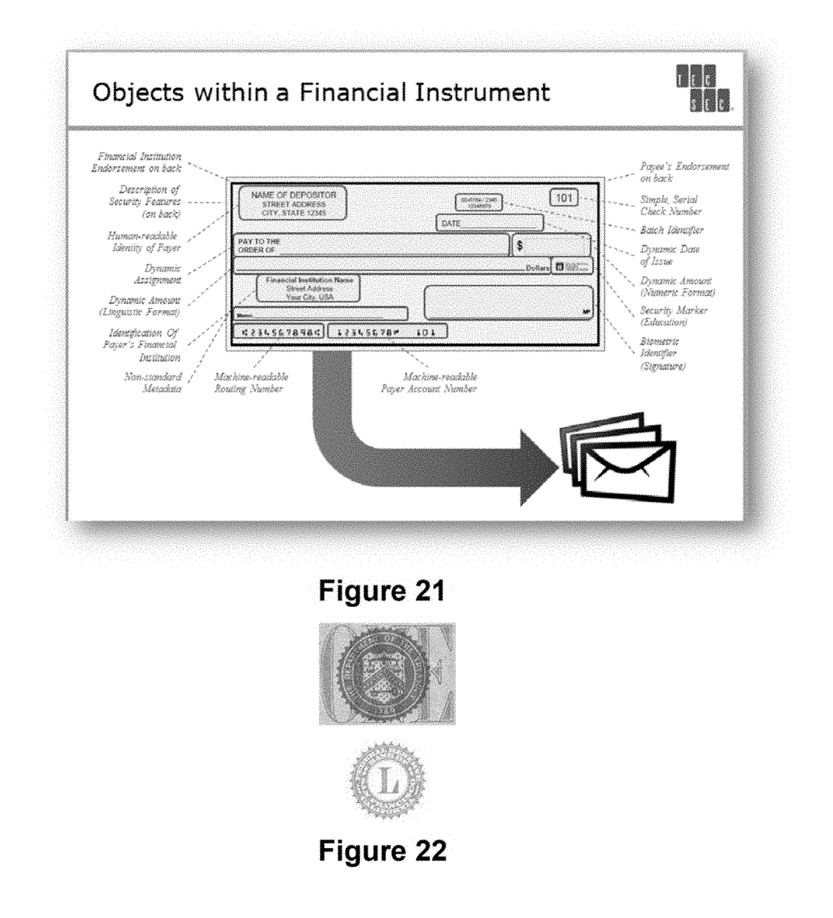

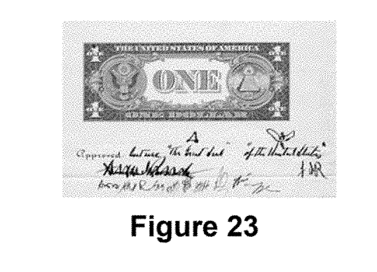

The following is a use case for the Information Collaboration Model of FIG. 10, with reference to FIGS. 11-17. An encryption process shown in FIG. 16 is applied to the transaction, which includes selected attributes.

The transaction data is encrypted and can be distributed and stored in formats such as the cloud or other remote storage. Other steps associated with a transaction can also include levels of access control with encryption enforcement. A business model can be established that includes which roles identity security should encompass as well as what overall security profile is needed.

A secure transaction can be viewed as a financial services event that must include what that financial security has established as its security profile. Legacy security models exist which would need to be included with a further notion that protecting at the data object level will include an implementation process that enhances existing security. A network security profile that relies on perimeter defenses will also need to include a migration to protecting data.

### Annex A.

### Setting the Security Stage

Over the past several years, we have witnessed the Internet, and related technologies, significantly change the complexion of distributed computing environments into a fundamental aspect of one's existence. A similar transformation has been taking place with security. A picture of a secure enterprise can now consist of different categories, defined as: Network Security, Device Security, and Information Security. FIG. 18 shows each of these security categories and lists their roles.

Attacks and threats have appeared in each security category A, example of a threat in the Network Security area would be the Distributed Denial of Service (DDOS). A threat example for Device Security is malware. And an example of a threat to Information Security is an attack on data. Common among the various protections are the control of access as well as providing confidentiality to the information within each of the categories being protected.

Encryption has emerged as a security tool that can augment security policy within these various security categories. The mathematics of encryption provides a basis for a high assurance that a process is executed as stated.

Over the years encryption has experienced advancements:

As a general form of providing confidentiality to information,

As a means for linking an action to an application and a bridge between an action entity and the application,

As an access enforcement for the information as an object,

As an inherent process in a portable hardware token that protects access to the token device, and

As a bridge among nested applications to ensure application and data separation.

Encryption can be included in various use cases:

Identity is a category of security. Different factors can be defined under identity. A biometric event, a password or a PIN, or a token have been used in identity applications. A biometric event, such a voice representing an individual, is an example of an identity factor. In this example, encryption can bind the voice biometric event to an authorization thereby limiting access to a specific individual or device. Another factor can be the creation of a password with an encryption technique. Finally, one or more identity factors can be used under a policy which becomes an input into an encryption process. The resultant encryption process further protects data as a collective identity for access to private information (or data).

Protecting and providing confidentiality to content (information or data) through encryption is another important category of security. Differential access to content is an encryption technique that can apply for use cases. An example might be found within common content such as a file that can contain various users, but differential access can be achieved, by granting access limits to the various users through a use-policy enforced with encryption. As an added dimension to persistent enforcement, encryption can bridge identity, authorization, access control, and data protection in a collected action.

Privacy and Liability can contain security issues for business usage. To prevent or to minimize the impact of a privacy issue or, of a liability issue, encryption can be exhibited in one or more roles such as identity enforcer, as an electronic signature, or as an authorization for limiting access to a specific action. Each role can be modeled to reinforce the legal objective defined under privacy or as a liability shield.

Protecting the application process with encryption access control can be another security layer.

A larger security picture emerges that builds on the financial services.

FIG. 19 illustrates an end-to-end security infrastructure that includes financial service security components. The security framework can accommodate a financial service customer or bank-to-bank content sharing. The infrastructure would include security tools such as routers, firewall, and encryption key management administration. The infrastructure can include a malicious Honeynet compartment for data that would be further handled separately from the main financial services process. Data can be tagged through an encryption header or non-encrypted metadata to provide differentiation to what is acceptable for further legitimate processing.

Applying encryption can be based on standards. Encryption paradigms appear in ANSI x9 standards, in the standards of the International Organization for Standardization (ISO), government bodies such as NIST, and an assortment of other standards bodies.

Within the x9 standards is the Cryptographic Message Syntax ASN and XML which defines various cryptographic capabilities and methodologies that can be applied to a financial services use case. To apply cryptography within a use case, an understanding of an encryption framework will be needed. The fundamentals of an encryption framework include the management and life cycle of encryption keys (an essential part of cryptography that is usually treated as secret). Differences in the mathematic makeup of encryption frameworks offer models that can be better suited for specific use cases.

A Certificate Authority can apply to a digital signature use case. A:signature framework can be applied to various content types. The cryptographic message syntax further identifies Enveloped Data which, in short, has content encrypted under a symmetric content-encryption key (CEK), and the CEK is, in turn, encrypted under each recipient's public key or a shared symmetric key, and included in the key management information. A hybrid key management and encryption framework under Enveloped Data is Constructive Key Management (CKM). Components of keying material, both symmetric and asymmetric type of keys, are combined together using a mathematical function to produce an object key. The asymmetric key components are associated with labels or credentials, which may be viewed as information identifiers, as roles, or as rules. An action with a credential may give access to a process, or access to a use-case application, or a more granular differential access with component-related labels, or may enforce a policy associated with access to a user case application. Once the object key (or a working key) has been created and used with an encryption algorithm such as AES, the encrypted data and a related metadata header can be viewed as ready to complete a user case action. The action of creating an object key for every use creates a dynamic key operation. Once the object key has been used, the object key is not reusable and is erased. Annex D includes further details associated with CKM.

Many use case applications can be derived from the encryption schema and frameworks identified in Annex D. Security with cryptography is always changing to adapt to the financial services markets needs and business models. History has illustrated changes in what can be defined as enterprise security categories. Addition and shifting has been taking place from a Network Security category, to a Device Security category, and currently to the Information Security Category.

### Annex B.

### Defining Objects for a Currency

Financial services have a long history of representing currencies as physical objects. In some business situations, digital representations are being used for payments and transactions, but the digital references are limited to identifying a currency. In 2015, the financial services industry has begun to discuss in earnest if, and how, a currency can have a digital representation managing specific objects associated with a currency. The objects can be addressed as data-aware objects or smart objects that are data label aware. Technology exists for a security architecture that can be applied directly to the identified objects. Leveraging ISO and TC68 standards may be a basis for going forward with identifying what constitutes objects within a currency, and, how these objects may be used to promote digital application usage.

### Objects as Units of Information

A digital object is are abstraction that can refer to any type of information. An object ma be considered a un it of information that includes properties (attributes or characteristics of the object) and may also include methods (means of performing operations on the object). The object may be simple or complex, ranging from values used in databases, to graphics and sounds. In addition to the data that, makes up the fundamental content, the object often includes metadata that describes the resource in a manner that supports administration, access, or preservation.

Objects can be defined through previous representations that can be found in physical correspondence and in a digital representation found in ISO 20022. Both of these are discussed below.

Objects within Correspondence

FIG. 20, illustrates an example of a collection of identified objects that are contained in a business piece of physical correspondence—an envelope. The objects are subjects associated with the United States postal guidelines for mailing an envelope. The correctness of each of the objects ensures the correct delivery of the correspondence.

Objects Identified with an International Payment Schema

Objects representing information and data have been standardized. An example of leveraging objects in a digital format can be seen in the ISO 20022 standard. Note that the 20022 methodology follows the concept found for physical representations in that ISO components are treated as objects and identify the necessary collection of components to constitute a payment message or a financial transaction.

In the ISO context, the standard describes the agreement on what information is expressed, while the syntax is the format or the language used to express that information. A message definition provides a clear classification of the information and data formats (field lengths, codes character sets) that can be exchanged between parties and can be looked at logically as a description of what data is exchanged in the message, its structure, and what it means. These logical definitions can be mapped to the business definitions set out in ISO 20022. Although ISO does not dictate the syntax of the messages, XML is the most widely used syntax for message specifications, currently, and XML message schemas are derived from the ISO UML message models.

ISO 20022 messages are available for the complete end-to-end payments chain: customer-to-bank (payment), bank-to-bank (payment clearing and settlement), and reporting (cash management). These financial message definitions are divided into business areas (these are well-recognized functional domains in the industry) and are identified by business area codes (4 characters). These codes are:

acmt—Account Management

admi—Administration

caaa—Acceptor to Acquirer Card Transactions

camt—Cash Management

catm—Terminal Management

pacs—Payments Clearing & Settlement

pain—Payments Initiation

reda—Reference Data

seev—Securities Events

semt—Securities Management

sese—Securities Settlement

setr—Securities Trade

trea—Treasury

tsmt—Trade Services Management

tsin—Trade Services Initiation

The message flows that represent a particular business transaction comprise messages from the business areas defined above. For example, a customer-initiated direct debit initiation message (pain.008.001.03) will result in a customer payment status report message (pain.002.001.04). Full details of the message flows for all business areas can be found in the ISO Payments Messages section of the ISO 20022 website.

Objects within a Financial Instrument

FIG. 21, illustrates a bridge between physical financial instruments in which objects have been identified. The bank check with its defined objects can be further linked to a virtual environment through its data objects (the entire check can be represented as a digital graphic). Like the envelope, the check contains these objects to enable a correct banking action, such as a deposit of funds. Each object, like the Routing and Transit Number (RTN), may be treated in an independent role, and subsequently used in a collective database—in essence, a data object can have more than one usage, whereas the check itself may be limited to a single role.

### Objects for Electronic Money

Electronic money, or ‘e-money’ can take several forms. For example, it can be the money balance recorded electronically on a stored-value card. These cards have embedded microprocessors that can be loaded with a monetary value. Another form of electronic money is network money, meaning software that allows the transfer of value on computer networks, particularly the Internet. Generally, electronic money is a floating claim on a private bank or other financial institution that is not linked to any particular account. Or, technology can be used to create “Electronic Money” that is anonymous like cash and not identified to a particular account. Other examples of electronic money are bank deposits, electronic funds transfer, direct deposit, and payment processors. Electronic money can either be centralized, where there is a rural point of control over the money supply, or decentralized, where the control over the money supply can come from various sources. Electronic money that is decentralized is also known as digital currencies, or where cryptographic security is used, as crypto currency. The major difference between e-money and digital/crypto currencies is that e-money doesn't change the value of the fiat currency (USD, EUR) it represents, whereas digital/crypto currency is not necessarily equivalent to any fiat currency, assuming it is not “issued” by a central monetary authority/government (e.g., Bitcoin). In other words, under these definitions all digital currency is electronic money, but electronic money is not necessarily digital currency, unless the digital currency is issued by a central monetary authority/government as “fiat-backed” currency.

Also, many mobile sub-systems have been introduced in the past few years including Google Wallet and Apple Pay. These mobile applications have taken various formats that can be viewed as objects to exercise the payment.

A currency is the value associated with the electronic money application. Therefore, electronic money can be viewed as a potential stepping stone to applying a digital currency once its objects are defined in a standard.

Objects within a Currency

Today's currency takes various forms. In past years, gold was considered a form of currency in the United States with fiat currencies. The following illustration is based on a United States Dollar (USD) but a parallel examination can be done with other national currencies.

In identifying objects for a currency, there are at least two directions to consider: objects that are associated with handling the currency and objects that are associated with the security used in the currency.

### Objects for Handling the Currency

To provide identity for the currency, various pictures are included. The USD includes a picture of the US Treasury seal and a Federal Reserve seal, as shown in FIG. 22, a detail of the Treasury Seal as it appears on a $1 bill, and an exemplary Federal Reserve Bank Seal (for San Francisco) as it appears on a $1 bill.

Other identifying components are included in the dollar representation, such as a portrait and other items that would further identify a dollar from the United States.

The reverse of the one-dollar bill as illustrated in FIG. 23 has an ornate design that incorporates both sides of the Great Seal of the United States to the left and right of the word “ONE”. This word appears prominently in the white space at the center of the bill in a capitalized, shadowed, and seriffed typeface. A smaller image of the word “ONE” is superimposed over the numeral “1” in each of the four, corners of the bill along with other identifying features.

The Dollar currency also includes various security objects such as watermarks, color shifting ink, and advanced counter forgery techniques. Most of these objects can be represented in a digital format. Additional and different types of security objects are needed to address the risk of a digital forgery.

### Objects to Build a Security Schema

Having access to data objects related to a digital currency can offer an efficient means to establish granular levels of confidentiality, data integrity, and security. Some of the physical security techniques used in the dollar have a minimum countermeasure impact when transformed into a digital environment.

Adding encryption as an enforcement capability at the object level presents a potential countermeasure for environments in which threats will be challenged. Attributes associated with objects can be apparent to selected entities while transparent to the consumer using a digital currency.

Thus, blockchain can be seen as sort of an applied hash, providing little or no confidentiality but instead providing the mathematical proof of non-alteration. However, as described herein, encryption can be provided of parts of a given transaction, form, or information exchange. Fixed key cryptography can be used in this application. However, this solution will not scale, nor will it work for data over time. Because people within organizations come and go and the now-immutable data must be able to be seen over time, use of a group key would mean that lots of people would have that group key, so many that any sense of security or protection would be impractical. The blockchain solution addressed herein, particularly as applied to financial and healthcare applications, provides persistent protection over time and differential access by attribute rather than a fixed key.

We claim:

1. A system for providing a cryptographic platform for exchanging information within an organization, the system comprising:
an interface configured to receive prepositioned split key values associated with attributes reflecting a taxonomy of the organization; and
one or more physical computer processors, coupled for communication with the interface and configured by machine-readable instructions to identify a first information transaction stored within a blockchain sequence that provides a verifiable record of information transactions, wherein the first information transaction represents an immutable record of a transfer of information to a first party, and the first information transaction includes a first information transaction identifier and a first information payload;
wherein the first information transaction identifier is associated with the first party and provides identification of the information transferred to the first party and stored within the blockchain encrypted based on a transaction ephemeral key created from the prepositioned split values;
wherein the first information transaction is identified based on the first information transaction identifier; and
wherein the first information identifier includes a hash of the first information payload enabling the auditing and verification of the information transferred to the first party and stored within the block chain, in its encrypted state and as such without disclosing the information transferred to the first party.

2. The system of claim 1, wherein:
the first information payload includes an attribute based, split key-constructed payload ephemeral key based encrypted version of the information transferred to the first party; and
wherein the encrypted version is encrypted using a payload ephemeral key associated with the first party and participating organizational key values so that the information transferred to the first party and stored within the blockchain is not publicly accessible via the blockchain.

3. The system of claim 2, wherein the one or more physical computer processors are further configured by the machine-readable instructions to:
retrieve the first information payload from the first information transaction stored within the blockchain;
decrypt the encrypted version of the information transferred to the first party using a decryption ephemeral key construction based on split values reflecting the taxonomy of the organization of interest inclusive of at least the first party that corresponds to the intent of the access desired by at least the first party; and
facilitate presentation of the decrypted information to the first party via an electronic display.

4. The system of claim 3, wherein the one or more physical computer processors are further configured by the machine-readable instructions to:
identify a second party as a source of the first information transaction; and
receive second information from the first party, wherein the second information includes a communication intended for the second party.

5. The system of claim 4, wherein the one or more physical computer processors are further configured by the machine-readable instructions to encrypt the second information with a second transfer ephemeral key construction based on split values reflecting the taxonomy of the organization of interest inclusive of the first and second parties that corresponds to the intent of the access desired by the first and second parties.

6. The system of claim 5, wherein the one or more physical computer processors are further configured by the machine-readable instructions to generate a second information transaction including a second information payload;
wherein the second information payload includes a first portion and a second portion;
wherein the first portion is encrypted using a first portion payload ephemeral key construction based on split values reflecting the taxonomy of the organization of interest inclusive of the first and second parties that corresponds to the intent of the access desired by the first and second parties; and
wherein the second portion is encrypted using a second portion payload ephemeral key construction based on split values reflecting the taxonomy of the organization of interest inclusive of the first and second parties that corresponds to the intent of the access desired by the first and second parties.

7. The system of claim 1, further comprising at least one key split generator, configured to couple for communication with the interface and to generate the propositioned split key values.

8. A method of providing a cryptographic platform for exchanging information, implemented on a computer system having one or more physical processors configured by machine-readable instructions which, when executed, perform the method, the method comprising:
identifying a first information transaction stored within a blockchain sequence that provides a mathematically verifiable record of information transactions, wherein the first information transaction represents an immutable record of a transfer of information to a first party and includes a first information transaction identifier and a first information payload;
associating the first information transaction identifier with the first party such that the first information transaction identifier provides identification of the information transferred to the first party and stored within the blockchain; and
identifying the first information transaction based on the first information transaction identifier, to provide a first information identifier that includes a hash of the first information payload, thereby enabling auditing of the information transferred to the first party and stored within the block chain without disclosing the information transferred to the first party.

9. The method of claim 8, wherein the first information payload includes an encrypted component, the method further comprising computing the encrypted component using a payload ephemeral key construction based on split values.

10. The method of claim 9, further comprising generating the split values.

11. The method of claim 9, wherein the split values reflect a taxonomy of an organization of interest inclusive of the first party corresponding to an intent of access desired by participants in the first information transaction.

12. The method of claim 11, wherein the split values reflect a taxonomy of an organization of interest inclusive of the first party and at least one other party corresponding to an intent of access desired by participants in the first information transaction.

13. The method of claim 8, further comprising encrypting the information transferred to the first party using a transfer ephemeral key construction based on split values reflecting the taxonomy of the organization of interest inclusive of the first party corresponding to the intent of access desired by at least the first party in the first information transaction, thereby rendering the information transferred to the first party and stored within the blockchain inaccessible publicly via the blockchain.

14. The method of claim 13, further comprising:
retrieving the first information payload from the first information transaction stored within the blockchain;
decrypting the encrypted information transferred to the first party using a decryption ephemeral key construction based on split values reflecting the taxonomy of the organization of interest inclusive of at least the first party that corresponds to the intent of the access desired by at least the first party; and
facilitating presentation of the decrypted information to the first party via an electronic display.

15. The method of claim 14, further comprising:
identifying a second party as a source of the first information transaction; and
receiving second information from the first party, wherein the second information includes a communication intended for the second party.

16. The method of claim 15, further comprising encrypting the second information using a second transfer ephemeral key construction based on split values reflecting the taxonomy of the organization of interest inclusive of the first and second parties that corresponds to the intent of the access desired by the first and second parties.

17. The method of claim 16, further comprising:
generating a second information transaction including a second information payload, wherein the second information payload includes a first portion and a second portion;
encrypting the first portion using a first portion payload ephemeral key construction based on split values reflecting the taxonomy of the organization of interest inclusive of the first and second parties that corresponds to the intent of the access desired by the first and second parties; and
encrypting the second portion using a second portion payload ephemeral key construction based on split values reflecting the taxonomy of the organization of interest inclusive of the first and second parties that corresponds to the intent of the access desired by the first and second parties.
